(19) United States
(12) Patent Application Publication
(10) Pub. No.: US 2017/0109764 A1
(43) Pub. Date: Apr. 20, 2017

(54) SYSTEM AND METHOD FOR MOBILITY DEMAND MODELING USING GEOGRAPHICAL DATA

(71) Applicant: XEROX CORPORATION, Norwalk, CT (US)

(72) Inventors: Abhishek Tripathi, Bangalore (IN); Guillaume M. Bouchard, Saint-Martin-Le Vinoux (FR); Frédéric Roulland, Le Versoud (FR)

(73) Assignee: XEROX CORPORATION, Norwalk, CT (US)

(21) Appl. No.: 14/886,730

(22) Filed: Oct. 19, 2015

(51) Int. Cl. G06Q 30/02; G06Q 50/30; G06Q 10/06

(52) U.S. Cl. CPC G06Q 30/0202; G06Q 30/0205; G06Q 10/067; G06Q 50/30

(57) ABSTRACT

A method for mobility demand modeling uses passenger demand data and geographical data for a transportation network. The demand data includes, for each of a plurality of stops in the transportation network, a passenger demand for each of a plurality of time intervals. The geographical data includes, for each of the plurality of stops in the transportation network, geographical features representing local points-of-interest. A dependence between the demand data and the geographical data is modeled by learning first and second mapping functions for embedding the demand data and the geographical data into the same latent space. The first and second mapping functions are learnt so as to optimize a correlation between the passenger demand data and the geographic data in the latent space. From the model, a prediction of passenger demand or of local point of interest for a proposed stop in the transport network can be generated.

### BACKGROUND

The exemplary embodiment relates to multi-view learning and finds particular application in connection with a system and method for modeling the dependence between mobility demand in public transportation systems and geographical features or points-of-interest (POIs).

Public transportation networks generally include multiple vehicles, routes, and services that are utilized by a large number of users. Such networks may include automatic ticketing validation systems that collect validation information for travelers. Understanding and optimizing the mobility of people utilizing public transportation systems is advantageous for transportation authorities. For example, growing traffic congestion and the pollution that it generates has a significant impact on the daily productivity and perceived quality of life of citizens. Public transportation routes include a number of stops at which a vehicle stops in a sequence, allowing passengers to alight or board the vehicle. The stops may not always be in useful positions for passengers, often having been selected many years earlier. To improve public transportation services it is desirable to be able to determine whether there would be a demand for additional stops on a public transportation system, before making changes to the route.

Currently, new stops are often determined by conducting passenger surveys. However, these are time consuming and often incomplete due to the limited number of passengers surveyed.

There is often a considerable amount of data available to network planners, such as from automatic passenger counting (APC) and automatic ticket validation (ATV) systems that are used to collect the data. While the data is useful in understanding and monitoring the transportation flows across a city, it does not provide information about stops which do not yet exist.

Existing systems for predicting mobility demand coming from transportation flows, such as public buses have used modeling techniques, such as Gaussian Process Regression. See, Bhattacharya, “Gaussian process-based predictive modeling for bus ridership,” Proc. ACM Conf. on Pervasive and Ubiquitous Computing Adjunct Publication, pp. 1189-1198 (2013). Bhattacharya predicts bus ridership using historical data from bus ridership, bus probe data and weather data. The methods disclosed in Bhattacharya, however, only predict demand for public transport at an existing bus stop for which there is historical data available.

There remains a need for a system and method for learning and using a mobility demand model for predicting demand at proposed new stops in an existing transportation network.

### INCORPORATION BY REFERENCE

The following references, the disclosures of which are incorporated herein by reference in their entireties, are mentioned:

U.S. Pub. No. 20130185324, published Jul. 18, 2013, entitled LOCATION-TYPE TAGGING USING COLLECTED TRAVELER DATA, by Guillaume M. Bouchard, et al.

U.S. Pub. No. 20130317742, published Nov. 28, 2013, entitled SYSTEM AND METHOD FOR ESTIMATING ORIGINS AND DESTINATIONS FROM IDENTIFIED END-POINT TIME-LOCATION STAMPS, by Luis Rafael Ulloa Paredes, et al.

U.S. Pub. No. 20130317747, published Nov. 28, 2013, entitled SYSTEM AND METHOD FOR TRIP PLAN CROWDSOURCING USING AUTOMATIC FARE COLLECTION DATA, by Boris Chidlovskii, et al.

U.S. Pub. No. 20130317884, published Nov. 28, 2013, entitled SYSTEM AND METHOD FOR ESTIMATING A DYNAMIC ORIGIN-DESTINATION MATRIX, by Boris Chidlovskii.

U.S. Pub. No. 20140089036, published Mar. 27, 2014, entitled DYNAMIC CITY ZONING FOR UNDERSTANDING PASSENGER TRAVEL DEMAND, by Boris Chidlovskii.

U.S. application Ser. No. 14/737,964, filed Jun. 12, 2015, entitled LEARNING MOBILITY USER CHOICE AND DEMAND MODELS FROM PUBLIC TRANSPORT FARE COLLECTION DATA, by Luis Rafael Ulloa Paredes, et al.

### BRIEF DESCRIPTION

In accordance with one aspect of the exemplary embodiment, a method for modeling mobility demand includes providing passenger demand data for a transportation network. The passenger demand data includes, for each of a plurality of stops in the transportation network, a passenger demand for each of a plurality of time intervals. Geographical data for the transportation network is also provided, the geographical data comprising, for each of the plurality of stops in the transportation network, geographical features representing local points-of-interest. A dependence between the passenger demand data and the geographical data is modeled. The modeling includes learning a first mapping function for embedding the passenger demand data into a latent space, and learning a second mapping function for embedding the geographical data into the latent space. The learning of the first and second mapping functions optimizes a correlation between the passenger demand data and the geographic data in the latent space.

One or more of the steps of the method may be performed with a processor.

In accordance with another aspect of the exemplary embodiment, a system for predicting mobility demand is provided. The system includes a learning component which receives passenger demand data and geographical data for a transportation network. The passenger demand data includes, for each of a plurality of stops in the transportation network, a passenger demand for each of a plurality of time intervals. The geographical data includes, for each of the plurality of stops in the transportation network, geographical features representing local points-of-interest.

The learning component generates a dependence model between the passenger demand data and the geographical data. The learning includes learning a first mapping function for embedding the passenger demand data into a latent space, and learning a second mapping function for embedding the geographical data into the latent space. The learning of the first and second mapping functions optimizes a correlation between the passenger demand data and the geographic data in the latent space. A prediction component generates a prediction based on the dependence model. A processor implements the learning component and prediction component.

In accordance with another aspect of the exemplary embodiment, a method for predicting mobility demand includes providing a passenger demand matrix for a transportation network, where each row of the passenger demand matrix represents a respective combination of a route ID and a stop ID in the transportation network, each row including a vector of values, each value representing a passenger count for a respective one of a plurality of time intervals. A geographical data matrix is also provided for the transportation network, where each row of the matrix represents a respective one of the combinations of route ID and stop ID in the transportation network, each row comprising a vector of values, each value representing a count of local points-of-interest for a respective one of a plurality of classes of points-of-interest. A first mapping function is learned for embedding the passenger demand matrix in a latent space. A second mapping function is learned for embedding the geographical data matrix in the latent space. The learning of the mapping functions optimizes a correlation between the passenger demand matrix and the geographic data matrix in the latent space. A prediction of passenger demand for a new stop in the transportation network is generated, based on the first and second mapping functions and the prediction is output.

At least one of the learning and the generating may be performed with a processor.

### BRIEF DESCRIPTION OF THE DRAWINGS

FIG. 1 is an overview of a mobility demand system and method;

FIG. 2 illustrates example matrices for the system;

FIG. 3 illustrates a part of a transportation network for illustrating the exemplary method;

FIG. 4 is a functional block diagram of a mobility demand system in accordance with one aspect of the exemplary embodiment;

FIGS. 5 and 6 together form a flow chart illustrating a method for predicting mobility demand in a transportation network in accordance with another aspect of the exemplary embodiment;

FIG. 7 is a plot which illustrates the prediction error for demographic features using demand and route information;

FIG. 8 is a plot which illustrates the hourly prediction of demand using demographic features; and

FIG. 9 is a plot which illustrates the daily prediction of demand of using demographic features.

### DETAILED DESCRIPTION

Aspects of the exemplary embodiment relate to systems and methods for generating a prediction for a public transportation network using a multi-view learning method. The prediction may be a predicted demand at a proposed stop location in a transportation network, such as a new bus stop or train station, or may be a prediction of points-of-interest (POIs) that are local to a given stop, e.g., within a predefined walking distance of the stop.

The exemplary system and method enable decisions to be made about infrastructure changes, such as whether to add a new bus stop to an existing route or routes, based on historical data. The exemplary systems and methods model not only the passenger flow in the existing routes but also model points-of-interest surrounding preexisting stops in a transportation network which are predicted to underlie the demand.

To quantify preexisting mobility demand of travelers in a transportation network, passenger demand (e.g., passenger count) matrices can be employed, which represent the spatial and temporal distribution of ridership demand at different stations in a transportation network. Each cell of the matrix may represent the number of passengers boarding (and/or alighting) at the stop in the time period, i.e., for whom the stop is the origin (or destination) of their journey on a route of the transportation network.

To quantify the POIs that are local to each of the stops in the transportation network, geographical POI matrices are used, which represent the quantity of different POIs surrounding stops in the transportation network. Each cell of the matrix may represent the number of POIs of each of a set of classes of POI surrounding a given stop in a transportation network.

A mobility demand model is developed from the combination of mobility demand data and geographical POI data using a multi-view learning method. The multi-view learning is performed using multivariate regression. The learned model can be used to predict the volume at a new location (such as new bus stop in a transit network) using points-of-interest in the neighborhood of the new location. The system and method assume that a correlation exists between the traffic flows at a given stop and the specific points of interests around the stop location. These points of interests, e.g. shopping malls, schools, stadiums, etc., are implicitly representative of a human activity and can be obtained from geographic databases or other resources.

A “transportation network,” as used herein, may include one or more routes, each route including a set of transit stops which are generally visited in a sequence by a vehicle of the transportation network. The exemplary transportation network is described in terms of a bus network, however, other public transportation networks, such as tram, rail, subway, and combinations thereof are contemplated. In another embodiment, the transportation network includes a set of refueling stops accessible to vehicles traveling on the transportation network. In yet another embodiment, the transportation network includes a set of parking locations accessible to vehicles traveling on the transportation network.

The term “passenger demand” or simply “demand,” as used herein, encompasses any measurement of the quantity (e.g., number) of passengers boarding and/or alighting a vehicle of a public transportation network at a given stop in a given time period. The demand at a given stop may be measured in terms of counts or estimated from other sources of data.

The term “point-of-interest” (POI) as used herein encompasses geographical locations near a given transit stop which may be a destination (or origin) for passengers of the transportation network. For example, points-of-interest may include venues such as schools, office buildings, restaurants, hospitals, train stations, entertainment venues, sporting venues, and like. It is assumed that the POIs local to a transit stop are closely related to the demand of the transit stop.

“Geographical features,” as used herein are features representing quantities of points-of-interest that are local to a given stop on a route of the transportation network and may further include other geographical features, as described below.

In the exemplary embodiment, a modeling method such as Canonical correlation analysis (CCA) or collective matrix factorization (CMF) is used to model correlation between demand of public transport stops and specific points-of-interest around them. Such joint modeling helps understand the relationship between the demand and the geographical surroundings of a transit stop. Furthermore, it enables predicting the demand for a proposed transit stop location (e.g., a new bus stop in the public transport network) given its surrounding points-of-interest.

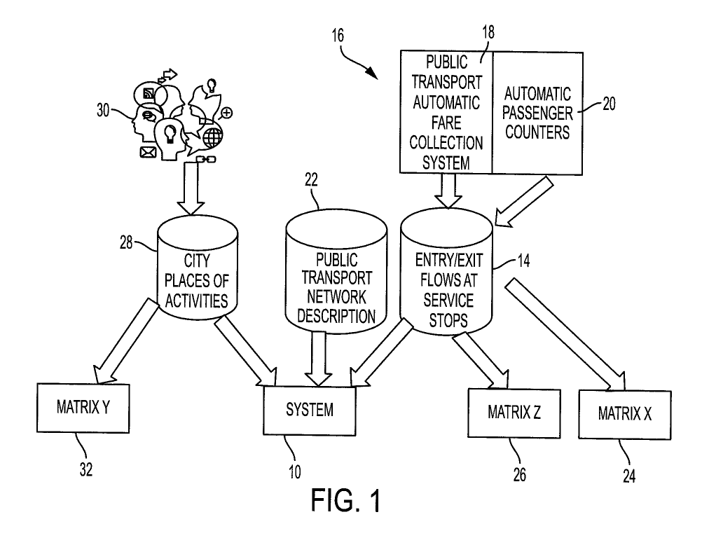

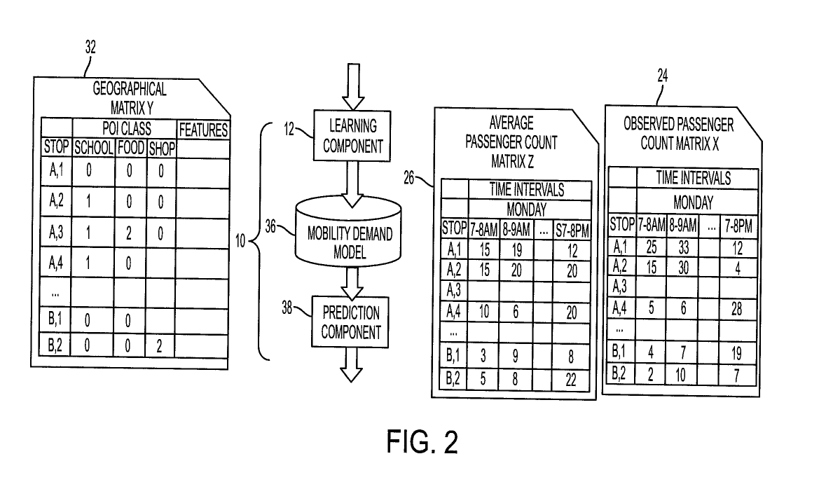

With reference to FIGS. 1 and 2, in an illustrative example, a mobility demand system 10 includes a learning component 12, which utilizes demand data 14 from a public transportation network 16 having entry/exit flows at transit stops. The network 16 may include sources of the demand data 14, such as an automatic fare collection system 18 and/or automatic passenger counters 20. For example, the entry and/or exit flow of people at transit stops of the public transportation network can be measured by public transport automatic fare collection devices 16 or automatic passenger counters 20. The system 10 may have access to a description 22 of the public transport network 16, e.g., provided by the transportation authorities, which enables the system 10 to understand how the stops are connected to each other through the routes of the network, and their graphical locations. The system 10 may collect and store the passenger count (demand) data 14 in a passenger count matrix 24, denoted X. The travel demand data 14 may include passenger counts for preceding and following stops in a transportation route which may be used to compute demand for an intermediate (new) stop. The intermediate stop data can be stored as the average demand of the preceding and following stops in an average passenger count matrix 26, denoted Z.

The learning component 12 also makes use of POI data 28, which includes POIs and their geographical locations. The POI data 28 may be collected from various public social web resources 30, which describe the type of activities happening in various places of a geographical region in which the transportation network is located, such as city. The data 28 may be stored in a geographical data matrix 32, denoted Y, which includes a set of graphical features, including points-of-interest (POI) features. A link between the activities and their geographical locations may be established through public social web resources such as Foursquare or OpenStreetMap.

Based on the collected demand data 14 and POI data 28 represented in the matrices 24, 26, 32, the learning component 12 learns a correlation between the demand data and geographical (e.g., POI) data using a statistical method as described below. The outcome of this learning phase is a statistical model 36 of the mobility demand, which predicts relationships (dependencies) between geographical features, such as POIs, and passenger demand.

Using the model 36, a prediction component 38 can be queried by a user who wants to evaluate the impact of a modification to the transportation network or who wishes to derive information on POIs. For example, a user might want to know what would be the change in demand if an additional transit stop is added (or removed) at a given location. The prediction component bases the prediction on the locations of nearby POIs. The model may also be used reciprocally to provide an estimate of the likely type of activities occurring in the neighborhood of one public transportation stop, based on the observed demand at this stop.

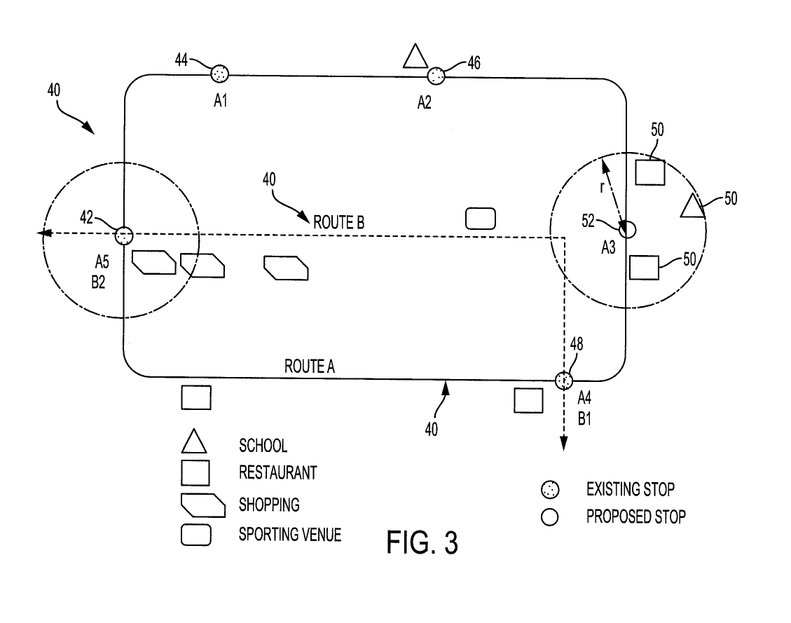

With reference also to FIG. 3, a transportation system, such as a public transportation system, includes a transportation network 40 with n points 42, 44, 46, 48, etc. (which may be referred to herein as stations or stops) and a predefined set of two or more routes 50, 52, etc., which connect the stops. The routes are each traveled by one or more transportation vehicles of the transportation system, such as public transport vehicles, according to predefined schedules. The transportation vehicles may be of the same type or different types (bus, train, tram, or the like). There may be five, ten, fifty, one hundred, or more stops on the transportation network and five, ten, thirty or more routes. Each route has a plurality of predefined stops, which are spaced in their locations, and in most or all cases, a route has at least three, four, five or more stops.

POIs 50 are located in the region of the transportation network and at least some of their locations, with respect to the transportation network, are presumed known. A class may be assigned to each known POI from a set of classes (school, restaurant, shopping, sporting in the illustrated embodiment). Each stop may have 0, 1, or more nearby POIs. For a proposed new stop 52, local POIs 50 within a predefined distance r of the stop location may be identified from the POI data 28. r may be defined as the walking distance, taking into account the locations of roads, or may be a direct distance, such as a predefined radius from the stop location. The distance r is selected as being one reasonably close to the stop such that a traveler would likely exit that stop due to its proximity to a given POI, rather than selecting a different stop (or choosing a different mode of transport). The number of POIs surrounding each stop can be counted within a radius r (or computed street distance) of, for example, 25 m, 50 m, 100 m, 200 m or more, depending on the nature of the transportation network at interest. In some embodiments, the radius may vary depending on the class of POI (e.g., assuming that students at a school may be willing to walk further than a shopper). The POIs 50 can include venues such as some or all of arts-entertainment, college-university, food, nightlife spots, outdoor/recreational, residential (which may be divided into two or more classes indicating the type of residence, e.g., apartments/condos and houses), professional places, shop-service, bus station, general-travel, train-station, hotel, moving-target, rental-car-location, road, and the like, depending on the information available. In general, there may be at least two, or at least three, or at least five, or at least ten such POI classes, and may be up to fifty or more.

Returning to FIG. 2, the demand (passenger-count) matrix 24 may be represented by rows {x₁^{d}, . . . , xₙ^{d}}^{T} where xᵢ^{d} is a vector of non-negative values representing the travel demand at the respective stop in each of a set of discrete time periods over, for example, the course of a day, for each of a set of days t=1 to T. In one embodiment, each column of the matrix 24 represents a discrete time interval during a 24 hour period. In other embodiments, the data may be aggregated by days, for example, one time period could be the average for weekdays from 8-9. Each stop can be represented as at tuple {Route Id, Stop Id}. For example, each row includes an estimation of the demand (e.g., number) of travelers boarding at that stop for each of the given time periods. The passenger-count matrix 24 thus represents the flow of travelers on the network. The matrix 24 may be estimated, for example, based on ticket information over a period of time such as several days, weeks, or months. There may be more than one matrix 24. For example, one matrix could be generated based on information obtained for weekdays over the course of a month in periods covering the morning peak travel period, another matrix for the weekday afternoon peak travel period, another for off-peak or weekend periods, or any suitable time granularity.

The geographical data (POI-based) matrix 32 can be represented by its rows as {y₁^{d}, . . . yₙ^{d}}^{T}, where yᵢ^{d} is a vector of non-negative values representing the quantity of each different class of POI surrounding the respective stop on a transportation network. Each stop is again represented as a tuple {Route Id, Stop Id}. For example, each row includes a count of the POIs in each class near each stop from 1-n. The results may be quantized into a set of two or more bins, such as three (or more) bins covering the range of possible values for each POI class. In another embodiment, the counts in the matrix are a decreasing function of distance to each POI, thus giving more weight to closer POIs than to more distant ones.

To produce a geographical data matrix 32 of the same dimensionality (T×n) of each column as the matrix X, the rows may simply be repeated T times. The geographical POI features can be enriched with other features. The additional features in the matrix 32 may include some or all of: features representing stops near-by, whether a stop is close to another transportation network (e.g., a tram), whether a particular stop at the beginning or the end of a route, features counting different POIs near other stops along the same route, and binary indicators denoting whether a particular stop belongs to a given route or not. In another embodiment, these features are used to generate an additional feature matrix.

The average demand (average passenger count) matrix 26 can be represented by its rows as {z₁^{d}, . . . , z}^{T} where zᵢ^{d} is a vector of non-negative values representing the average demand for a stop, computed as the average (e.g., mean) of the pair of (immediately) preceding and following stops on the transportation network. Where there is no preceding (or following) stop, for example at a terminus, the actual count for the stop may be used. Each stop is again represented as a tuple {Route Id, Stop Id}. The average passenger count matrix 26 can be used for comparison data. In addition, the average passenger count matrix 26 can incorporated into the mobility demand model 36 in systems which can handle more than two data sets.

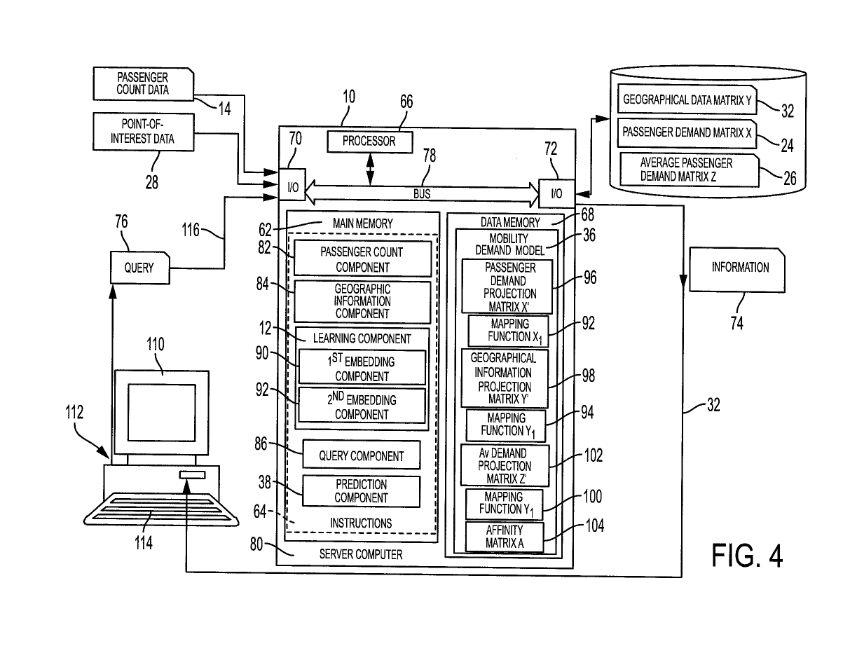

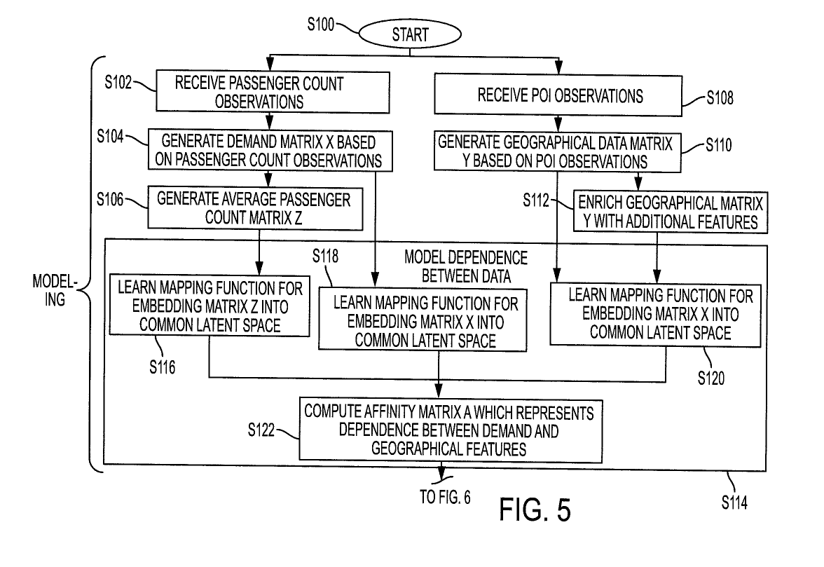

Referring now to FIG. 4, the system 10 includes main memory 62 which stores instructions 64 for performing the method illustrated in FIGS. 5 and/or 6 and a processor 66, in communication with the memory 62, which executes the instructions. Data memory 68, separate or integral with memory 62, stores data during processing, such as the passenger count data 14 and POI data 28, which may be received by an input/output (I/O) device 70 of the system. The same or a separate I/O device 72 may be used to output information 74 generated by the system, e.g., in response to a user query 76. Hardware components 62, 66, 68, 70, 72 of the system 10 are communicatively connected by a data/control bus 78. The system may be hosted by one or more computing devices, such as the illustrated server computer 80.

The instructions 64 may include several software components, here illustrated as the learning component 12, a passenger count component 82, a geographical information component 84, a query component 86, and the prediction component 38. The learning component 12 may include at least one of a first embedding component 90 and a second embedding component 92.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

Briefly, the passenger count component 82 uses the passenger count data 14 to generate the passenger count matrix 24, denoted X. The geographical information component 84 uses the POI data 28 (and optionally other features, as noted above) to generate the geographical data matrix 32, denoted Y. In some embodiments, the passenger count component 82, or separate component, uses the passenger count data 14 to generate an average passenger demand matrix 26, denoted Z, which may be used in addition to or in place of matrix X. The matrices 24, 26, 32 may be stored in local and/or remote memory communicatively connected with the system. While the matrices X and Y may have the same column dimensionality (same number of rows), they have different row dimensionality (different numbers of columns/features). In order to determine the correlation between them they are embedded into a common latent space with a fixed number of features, such as at least 8 or at least 12 features.

In one embodiment, the first embedding component 90, where present, embeds matrices 24 and 32 into a common latent space by learning mapping functions 92, 94, denoted X₁ and Y₁, respectively, for the two matrices X, Y which optimize a correlation between the embedded passenger demand projection matrix 96, denoted X′ and a geographical information projection matrix 98, denoted Y′ and vice versa. The latent space may have a different (e.g., higher) dimensionality than the two matrices X and Y. The first embedding component 90 may employ the learned mapping function X₁ to generate the passenger demand projection matrix 96, which is the product of the matrix X and the mapping function X₁. Additionally the first embedding component 90 employs the learned mapping function Y₁ to generate the geographical information projection matrix 98, which is the product of the matrix Y and the mapping function Y₁. The mapping functions X₁ and Y₁ may be 1D or 2D tensors (vectors or matrices). The projection matrices X′, Y′ and/or the mapping functions X₁ and Y₁ may be stored in the mobility demand model 36, e.g., in memory 68. The learning of the mapping functions X₁ and Y₁ optimizes parameters, such as the number of elements in each row of the latent space and optimizes (e.g., maximizes) the correlation between the embedded passenger count matrix X′ and the embedded POI matrix Y′.

In another embodiment, the first embedding component 90, where present, embeds matrices 26 and 32 into a common latent space by learning mapping functions 98, 94, denoted Z₁ and Y₁, respectively, for the two matrices Z, Y which optimize a correlation between the embedded average passenger demand projection matrix 102, denoted Z′ and the geographical information projection matrix 98, denoted Y′ and vice versa.

The first embedding component may employ CCA to learn the mapping functions X₁, and Y₁ or Z₁ and Y₁ and to generate a dependence model such as an affinity matrix A 102, from the embedded matrices which describes the relationship between the (embedded) geographical features and the demand.

In yet another embodiment, the second embedding component 92, where present, embeds matrices 24, 26, and 32 into a common latent space by learning mapping functions X₁, Y₁, and Z₁, respectively, for the three matrices X,Y,Z which optimize a correlation between the embedded matrices X′, Y′ and Z′. Thus, in addition to projection matrices X′, Y′ a third, average demand projection matrix 100 is learned. The second embedding component may employ CMF to learn the mapping functions X₁, Y₁, and Z₁ and to generate an affinity matrix A 102, from the embedded matrices which describes the relationship between the geographical features and the demand.

Although the second embedding component 92 may optimize the correlation between three embedded matrices X′, Y′ and Z′, the method is not limited to three matrices. For example, a fourth matrix may include other information, such as the availability of other modes of transport for each stop, the availability of public parking near the stop, and so forth. CMF is thus a more general case of the CCA method, but which is not limited to two input matrices. As for the CCA method, the CMF method uses the three (or more) matrices 24, 26, 32 to jointly learn mapping functions X₁, Y₁, and Z₁ which optimize the correlation between the embedded matrices X′, Y′ and Z′ in the common latent space. The mapping functions X₁, Y₁ and Z₁ may be 1D or 2D tensors (vectors or matrices). The projection matrices X′, Y′, and Z′ and/or the mapping functions X₁, Y₁ and Z₁ may be stored in the model 36 in memory 68. The learning of the mapping functions X₁, Y₁, and Z₁ optimizes parameters, such as the number of elements in each row of the latent space and optimizes (e.g., maximizes) the correlation between the mapped passenger count matrix X′, mapped POI matrix Y′, and mapped average passenger demand matrix Z₁. As will be appreciated, once the mapping functions X₁, Y₁ and Z₁ which optimize the joint correlations between the embedded matrices have been learned, the mapping function Z₁ and its matrix Z′ are no longer needed and can be omitted from the system.

The query component receives as input a query 76, e.g., generated by a user on a client device 100, which may be communicatively connected with the system by a wired or wireless link 102, such as the Internet. The query may be a query for predicting demand for a proposed new stop on a route of the transportation network, such as stop 52 in the network of FIG. 2. Or, the query may be for predicting points of interest within a predetermined distance r of an existing stop. The query component may generate a new row of the respective matrix 24 or 32, depending on the type of query. If the query is for predicting demand for a proposed new stop, an empty row is generated for the passenger count matrix. A corresponding row of the POI matrix may be completed based on the point of interest data 28. If the query is for predicting points of interest within a predetermined distance r of a preexisting stop, an empty row is generated for the POI matrix.

The prediction component 38 computes the missing values of the appropriate matrix X or Y using the model 36. In the case of a proposed stop, the geographical features of the new location may be embedded in the latent space with the mapping function Y′ and the predicted embedded demand obtained from the affinity matrix A are output. The embedded demand is then converted to the predicted demand for the stop using the mapping function X′. If the predicted demand exceeds one or more thresholds for given day(s) or time period(s), or in total, the prediction component may output a recommendation for the stop to be added to the route. In the case of predicting geographical features, such as POIs, the demand vector(s) of the stop may be embedded in the latent space with the mapping function X′ and the predicted embedded geographical features obtained from the affinity matrix A are output The embedded geographical features are then converted to the predicted geographical features for the stop using the mapping function Y′.

The output 74 of the prediction component may be a vector of elements corresponding to the missing row of the passenger count matrix X (or POI matrix Y), or information based thereon.

The information 74, or a representation thereof may be output to an output device 110, such as a display device and/or printer. The exemplary display device 110 is shown as a screen of an associated client device 112. A user input device 114, such as a keyboard or touch or writable screen, and/or a cursor control device, such as mouse, trackball, or the like, can be used by a user for inputting the query 76 and for communicating user input information and command selections to a processor of the client device 112. The client device 112 may be linked to the server computer by one or more wired or wireless link(s) 116, such as a local area network or a wide area network, such as the Internet. Alternatively, the display device and/or user input device may be directly linked to computer 80.

The computer system 10 may include a PC, such as a desktop, a laptop, palmtop computer, portable digital assistant (PDA), server computer, cellular telephone, tablet computer, pager, combination thereof, or other computing device capable of executing instructions for performing the exemplary method.

The memory 62, 68 may represent any type of non-transitory computer readable medium such as random access memory (RAM), read only memory (ROM), magnetic disk or tape, optical disk, flash memory, or holographic memory. In one embodiment, the memory 62, 68 comprises a combination of random access memory and read only memory. In some embodiments, the processor 66 and memory 62 and/or 68 may be combined in a single chip. The network interface 70, 72 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor 66 can be variously embodied, such as by a single-core processor, a dual-core processor (or more generally by a multiple-core processor), a digital processor and cooperating math coprocessor, a digital controller, or the like. The exemplary digital processor 66, in addition to controlling the operation of the computer 80, executes instructions stored in memory 62 for performing the method outlined in FIGS. 5 and/or 6.

The client device 112 may be similarly configured to server computer 80, with memory and a processor.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The modeling of the dependence between demand and geographic features can be done using several approaches. A transformation or mapping function is learned to embed the passenger count matrix into the latent space into which the geographical matrix can also be embedded. The aim of this mapping to maximize some measure of correlation between the two embedded data sets, e.g., to maximize over all pairs, the similarity between the pairs of representations in the latent space.

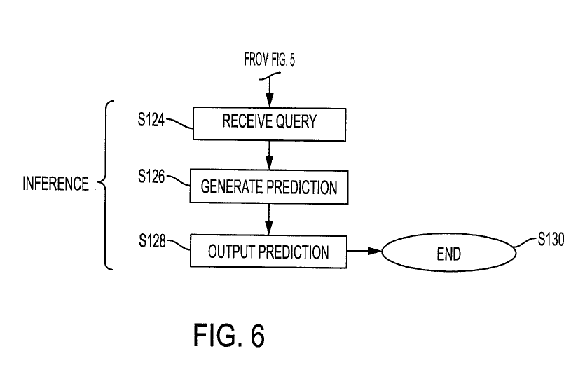

With reference to FIGS. 5 and 6, the exemplary prediction method is described, which can be performed with the system of FIG. 4. The method begins at S100.

In the modeling phase (FIG. 5), at S102, passenger count information, such as a collection of passenger count observations 14 in a transportation network, such as a public bus network having a predefined number of stops, is received, and may be stored in memory. The passenger count information can be obtained from collection devices such as automatic fare collection systems, automatic passenger counters, and the like.

At S104, a passenger demand matrix 24 is generated, based on the passenger count information, by the component 82, and may be stored in memory. The passenger demand matrix 24 represents the demand (e.g., count of people boarding and/or alighting) at each stop in the transportation network, for discrete time periods on a given day or days. Each row of the matrix 24 represents a stop on a particular route, stored as a tuple <Route ID, Stop ID>. Each row constitutes a vector of values, where each value represents a passenger count for a respective <Route ID, Stop ID>. In other embodiments, the passenger count matrix may have been previously generated. Each column of the matrix 26 represents a respective time interval, e.g., during a 24 hour period.

At S106, an average passenger demand matrix 26 may be generated based on the passenger count information, by the component 82, and may be stored in memory. Each row of the average passenger demand matrix 26 represents a stop on a particular route, which may be stored as a tuple <Route ID, Stop ID>. Each row comprises a vector of values. Each value represents the average demand at each <Route ID, Stop ID>, which is based on passenger counts at preceding and following stop ID's on the same route ID. Each column of the matrix 26 represents a respective time interval during a 24 hour period. The number of columns and rows is thus the same as for the matrix 24.

At S108, geographical data in the form of point-of-interest (POI) observations 28, and optionally other features, is received and may be stored in memory. The POI information can be obtained from social web applications which list the various POIs surrounding a particular stop in a transportation network. For one or more of the stops in the network, geographical data may be unavailable.

At S110, the geographical data matrix 32 is generated, based on the POI data 28. Each row of the matrix 32 represents a stop on a particular route, stored as a tuple <Route ID, Stop ID> (i.e., using the same set of tuples used in the matrix X). Each row constitutes a vector of values, each value representing a count of POIs local to that stop in the transportation network, with each column of the matrix 32 representing a class of POIs. The column dimensionality of the matrix 32 may be made the same as matrices 24 and 26 by repeating the set of rows T times.

At S112, f additional features may be added to the geographical data matrix 32 to enrich the geographical representation. The additional features may include a representation of “stops-near-by” a respective stop, a feature telling how close a respective stop is to the end of a respective route, features counting different POIs within a radius of other stops on a respective route, and binary indicator features indicating to which route a respective stop belongs. In another embodiment, the additional features are incorporated into a separate f×(nT) features matrix.

At S114, the dependence between the passenger demand matrix 24 and the geographical data matrix 32 (and optionally also the average passenger demand matrix 26) is modeled. In particular, a first mapping function or projection 92 is learned for mapping the passenger demand values into a common latent space (S116), a second mapping function or projection 94 is jointly learned for mapping the geographical features into the same latent space as the passenger demand values (S118) and optionally a third mapping function or projection 100 is jointly learned for mapping the average passenger demand values into the same latent space as the passenger demand and geographical feature values (S120). The mapping functions 92, 94, 96 are learned so as to optimize a correlation between the passenger demand values and geographical feature values in the latent space.

At S122 an affinity matrix 104 may be generated which represents the dependence between passenger demand and geographical features. This matrix may be a function of a product of the matrices X′ and Y′. This ends the modeling phase of the method, which may be performed offline, prior to receiving a query.

In the inference stage of the method (FIG. 6), at S124, a query is received, with a request for a prediction based on the model. The query may include a proposal for adding or removing a service stop at a given location on a preexisting route in a transportation network. Or the query may designate a stop in the network and request information on local points of interest.

At S126, a prediction is generated in response to the query. The prediction is based on the model 36. In the case of a new stop, the prediction is for passenger demand. Here a new empty row x is created in the matrix X. The local points of interest for the new stop can be extracted from the geographical data 28 and used to generate a corresponding row y in the matrix Y, which is then mapped with the mapping function Y₁ to generate a vector y′ in the latent space. Using the mapped vector y′, the dependency model 104 can be accessed to identify a corresponding vector x′, which can be mapped to values of row x using the mapping function X₁. If the query is for points of interest, the prediction may be for local points of interest using the reverse process. Here a new empty row y is created in the matrix Y. The passenger demand for the stop provides a corresponding row x in the matrix X, which is then mapped with the mapping function X₁ to generate a vector x′ in the latent space. Using the mapped vector x′, the dependency model 104 can be accessed to identify a corresponding vector y′, which can be mapped to values of row y using the mapping function Y₁.

At S128, the prediction 74 is output. For example, it may be sent directly to the client device 112.

The method ends at S130.

As will be appreciated, the prediction considers stops independently and does not take into account that some of the passengers using the new stop may have an impact on the demand at neighboring stops. However, this may be addressed by setting the thresholds or by modeling the impact on the neighboring stops by modifying their geographical features to exclude the POIs which are now closer to the new stop.

The method illustrated in FIGS. 5 and/or 6 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications and the like.

The exemplary method may be implemented on one or more general purpose computers, special purpose computer(s), a programmed microprocessor or microcontroller and peripheral integrate circuit elements, an ASIC or other integrated circuit, a digital signal processor, a hardwired electronic or logic circuit such as a discrete element circuit, a programmable logic device such as PLD, PLA, FPGA, Graphical card CPU (GPU), or PAL, or the like. In general, any device, capable of implementing the flowchart shown in FIGS. 5 and/or 6, can be used to implement the method.

Further details of the system and method will now be described.

Learning the Model with CCA

In an exemplary embodiment, a first approach to modeling demand, i.e., maximizing the correlation between the embedded matrices, can be performed using a Bayesian formulation of Canonical Correlation Analysis (CCA). CCA is a method to find statistical dependence between two data sources, i.e., to learn the latent space of passenger count matrix X (or Z) and geographical matrix Y. In case of passenger count matrix and geographic matrix, CCA finds a relationship between passenger counts at different times of day and points-of-interest at each bus stop. This relationship is determined in a feature space that maximizes the correlation between the projected representations.

A Bayesian CCA solution with a group-wise sparsity prior developed by Klami, et al. may be employed. See, Arto Klami, et al., “Bayesian Canonical Correlation Analysis,” J. Machine Learning Research, 14:965-1003, 2013. This method provides a solution for hierarchal extensions and combination of data sets with large dimensionalities and small sample size. The solution imposes group-wise sparsity to estimate the posterior of an extended model which not only extracts statistical dependencies between data sets but also decomposes the data into shared and data set-specific components. One suitable software package is available at http://cran.r-project.org/web/packages/CCAGFA/, which provides variational Bayesian algorithms for learning with CCA. The package provides a scalable version of CCA that does not require the inversion of large matrix. Two data sources with coupled samples are included: (1) the passenger count data; and (2) the neighborhood data. Both sets of data can be stored in respective matrices X and Y (referred to as X⁽¹⁾ and X⁽²⁾, in the package). The shared latent sources between the two data sources are modeled, but alternatively the model can be seen as multivariate regression from X⁽²⁾ to X⁽¹⁾. CCA is an advantageous approach that separately models the aspects in X⁽²⁾ that do not help in making the prediction as well as the aspects in X⁽¹⁾ that cannot be predicted.

In the classic CCA problem, when given two co-occurring random variables (here, passenger counts and points-of-interest) with N observations (here, stops in a transportation network) collected as matrices x⁽¹⁾εR^{D1×N} and x⁽²⁾εR^{D2×N}, the task is to find linear projections UεR^{D1×K} and VεR^{D2×K} (i.e., X₁ and Y₁) so that the correlation between uₖ^{T} X⁽¹⁾ and vₖ^{T}, X⁽²⁾ is maximized for the components k, under the constraint that uₖ^{T} X⁽¹⁾ and uₖ^{T}, X⁽¹⁾ are uncorrelated for all k≠k′ (and similarly for the other view). The solution can be found analytically by solving the eigenvalue problems:

$${C}_{11}^{- 1} {C}_{12} {C}_{22}^{- 1} {C}_{21} u = {ρ}^{2} u , \\ {C}_{22}^{- 1} {C}_{21} {C}_{11}^{- 1} {C}_{12} v = {ρ}^{2} v , \\ where \text{:}$$

$$C = [ \begin{matrix}{C}^{11} & {C}^{12} \\ {C}^{21} & {C}^{22}\end{matrix} ]$$

is the joint covariance matrix of x⁽¹⁾ and x⁽²⁾ and p denotes the canonical correlation. In practice all components can be found by solving a single generalized eigenvalue problem.

### The CCA Based Model

The Bayesian CCA solution is based on latent variable models and linear projections. At the core of the generative process is an unobserved latent variable zεR^{K×1}, which is transformed via linear mappings to the latent observation spaces to represent the two multivariate random variables x⁽¹⁾εR^{D1×1} and x⁽²⁾εR^{D2×1} where x⁽¹⁾ and x⁽²⁾ are passenger counts and points-of-interest, respectively. For these paired feature vectors, a correlation is maximized in a linear latent space by assuming a latent factor model for each observation through the shared unobserved latent variable zεR^{K×1}. The model may be written as a latent factor model by vertical concatenation of observations, linear projections, and Gaussian residual errors:

x⁽¹⁾˜N(A⁽¹⁾z+B⁽¹⁾z⁽¹⁾,Σ⁽¹⁾),

x⁽²⁾˜N(A⁽²⁾z+B⁽²⁾z⁽²⁾,Σ⁽²⁾),

with zεR^{K×1}, z⁽¹⁾εR^{K1×1}, and z⁽²⁾εR^{K2×1}. The latent vector z is shared by both x⁽¹⁾ and x⁽²⁾, and captures the variation common to both data sets through the linear mappings A⁽¹⁾z and A⁽²⁾z, where A^{(m)}εR^{Dm×K}. The variation specific to each view is modeled with view-specific latent variables z⁽¹⁾ and z⁽²⁾ which are transformed to the observation space by another linear mapping B⁽¹⁾z and B⁽²⁾z, where B^{(m)}εR^{Dm×Km}.

By inducing explicit blocks of zeros—that is, group-wise sparsity—in the combined loading matrix, the covariance across two observations and covariance local to each observation may be estimated. To learn the Bayesian CCA model with group-wise sparsity priors, the latent signals z and z″) are inferred along with the projections A^{(m)} and B^{(m)} from the two data sets. For this purpose, the posterior distribution p(z, z⁽¹⁾, z⁽²⁾, A⁽¹⁾, A⁽²⁾, B⁽¹⁾, B⁽²⁾, Σ⁽¹⁾, Σ⁽²⁾|X⁽¹⁾, X⁽²⁾), is estimated and marginalized over the possibly uninteresting variables. The basic Bayesian CCA model is reformatted by first defining x as the vertical concatenation of the two multivariate random variables where x=[x⁽¹⁾; x⁽²⁾]εR^{D×1} with D=D₁+D₂. Next, y is defined as the vertical concatenation of the three latent variables where y=[z; z⁽¹⁾; z⁽²⁾]εR^{Kc×1}; and K_{C}=K+K₁+K₂. This feature-wise concatenation of the data sources is analyzed with a single latent variable model with diagonal noise covariance ΣεR^{D×1} with the structure:

$$Σ = [ \begin{matrix}{Σ}^{( 1 )} & 0 \\ 0 & {Σ}^{( 2 )}\end{matrix} ] ,$$

where D=D₁+D₂, and a projection matrix WεR^{D×Kc} with the structure:

$$W = [ \begin{matrix}{A}^{( 1 )} & {B}^{( 1 )} & 0 \\ {A}^{( 2 )} & 0 & {B}^{( 2 )}\end{matrix} ] .$$

The model can thus be written as

y˜N(0,I),

x˜N(Wy,Σ).

The structure in the projection matrix W has a specific meaning, the non-zero columns (those in A⁽¹⁾ and A⁽²⁾) project the shared latent factors (i.e., the first K in y) to x⁽¹⁾ and x⁽²⁾, respectively. These latent factors represent the covariance across the data sets. The columns with zero blocks (those in [B⁽¹⁾; 0] or [0; B⁽²⁾]) relate specific factors to only one of the two data sets—they model covariance specific to that data set.

To implement the group-wise sparsity, the variables in x are divided into two groups corresponding to the two data sets, and a prior is constructed that encourages sparsity over these groups. For each component wₖ the elements corresponding to one group are either pushed all toward zero, or are all allowed to be active. Using a simple extension of the automatic relevance determination (ARD) prior used for component selection in many Bayesian component models, the correct form of sparsity can be obtained. Thus, the group-wise ARD is defined as:

p(W)=Πₘ₌₁²ARD(W^{(m)}|α₀,β₀),

with separate ARD prior for each W^{(m)}. Here W⁽¹⁾ denotes the first D₁ rows of W and W(2) refers to the remaining D₂ rows. The group-wise ARD makes unnecessary components wₖ^{(m)} inactive for each of the views separately. The components needed for modeling the shared response will have small αₖ^{(m)} (i.e., large variance) for both views, whereas the view-specific response will have small αₖ^{(m)} for the active view and a large one for the inactive one. Finally, the model still selects automatically the total number of components by making both views inactive for unnecessary components.

A variation approximation is applied for inference (prediction) using the factorized distribution

$$q ( W , {τ}_{m} , {α}^{( m )} , Y ) = {\prod }_{n = 1}^{N} q ( {y}_{n} ) {\prod }_{m = 1}^{2} ( q ( {τ}_{m} ) q ( {α}^{( m )} ) ) {\prod }_{d = 1}^{{D}_{1} + {D}_{2}} q ( {W}_{d , :} ) .$$

Here, W_{d} corresponds to the dth row of W, a vector spanning over the K different components. The different terms q(•) in the approximation are updated alternatingly to minimize the Kullback-Leibler divergence D_{KL}(q,p) between q(W,τₘ,α^{(m)},Y) and p(W,τₘ,α^{(m)},Y|X) to obtain an approximation best matching the true posterior. Equivalently, the task is to maximize the lower bound

$$ℒ ( q ) = log p ( X ) - {D}_{KL} ( q , p ) = \int q ( W , {τ}_{m} , {α}^{( m )} , Y ) log \frac{p ( W , {τ}_{m} , {α}^{( m )} , Y , X )}{q ( W , {τ}_{m} , {α}^{( m )} , Y )}$$

for the marginal likelihood, where the integral is over all of the variables in q(W,τₘ,α^{(m)}, Y). Since all priors are conjugate, variational optimization over q(•), constrained to be probability densities, automatically specifies the functional form of all of the terms.

Learning the Model with CMF

In another exemplary embodiment, a second approach to modeling demand can be done using Collective Matrix Factorization (CMF). CMF finds low-rank vectorial representations by approximating a matrix as the outer product of two rank-k matrices. In this multi-view learning approach, multiple matrices X,Y,Z, etc., are considered that share the same row entities but differ in column entities. For example, X may contain passenger counts given for d1 time intervals throughout a given day by n different stops in a transit network, whereas Y represents that same n different stops in a transit network with d₂ surrounding points-of-interest. Because CMF allows for consideration of multiple matrices, a third matrix Z may contain average passenger counts of preceding and following stops given for d₁ time intervals throughout a given day by the same n different stops in a transit network.

The goal of CMF is to jointly approximate a set of matrices with low rank factorizations. A set of M matrices Xₘ=[xᵢⱼ^{(m)}] describe relationships between E sets of entities (with cardinalities dₑ). The entity sets corresponding to the rows and columns of the m-th matrix are denoted by rₘ and cₘ, respectively.

### The CMF-Based Model

Each of the M matrices is approximated with a rank-K product plus additional row and column bias terms. For linear models, the element corresponding to the row i and column j of the m-th matrix is given by:

xᵢⱼ^{(m)}=Σₖ₌₁^{K}uᵢₖ^{(r}^{ₘ}⁾uⱼₖ^{(c}^{ₘ}⁾+bᵢ^{(m,r)}+bⱼ^{(m,c)}+εᵢⱼ^{(m)}

where Uₑ=uᵢⱼ^{(e)}εR^{d}^{ₑ}^{×K} is the low-rank matrix related to the entity set e, bᵢ^{(m,r)}, and bⱼ^{(m,c)} are the bias terms for the mth matrix, and εᵢⱼ^{(m)} is element-wise independent noise.

The same model can also be expressed in a simpler form by crafting a single large symmetric observation matrix Y_{M} that contains all Xₘ, which allows implementing the private factors via group-wise sparsity. One large entity set with d=Σₑ₌₁^{E}dₑ entities and then arrange the observed matrixes Xₘ into Y such that the blocks not corresponding to any Xₘ are left un-observed. The resulting Y_{M} is of size d×d but has only (at most) Σₘ^{M} dᵣ_{ₘ} d_{c}_{ₘ} unique observed elements. In particular, the blocks relating the entities of one type to themselves are not observed.

The CMF model can then be formulated as a symmetric matrix factorization:

Y_{M}=UU^{T}+ε,

where U=R^{d×K} is a column-wise concatenation of all of the different Ue matrices, and the bias terms are dropped for notational simplicity. To allow for matrix-specific low-rank variations, the basic formulation is extended using the following property of the basic CMF model: if the k-th columns of the factor matrices Uₑ are null for all but two entity types rₘ and cₘ, it implies that the k-th factor impacts only the matrix Xₘ, i.e., the factor k is a private factor for relation m. Group-sparse priors are placed on the columns of the matrices Uₑ to allow for the automatic creation of these private factors.

The general model is instantiated by specifying the Gaussian likelihood and normal-gamma priors for the projections, giving:

εᵢⱼ^{(m)}˜ [symbol] (0,τₘ⁻¹),τₘ˜ [symbol] (p₀,q₀),

uᵢₖ^{(e)}˜ [symbol] (0,αₑₖ⁻¹),αₑₖ˜ [symbol] (a₀,b₀).

where e is the entity set that contains the entity i. The purpose of the prior for U is to select automatically, for each factor, a set of matrices for which it is active, which it does by learning large precision αₑₖ for factors k that are not needed for modeling variation for entity set e. In particular, the prior takes care of matrix-specific low-rank structure, by learning factors for which αₑₖ is small for only two entity sets corresponding to one particular matrix.

A hierarchical prior is used for the bias terms:

bᵢ^{(m,r)}˜ [symbol] (uᵣₘ,σᵣₘ²),bⱼ^{(m,c)}˜ [symbol] (u_{cm},σ_{cm}²),

μₘ˜ [symbol] (0,1),σₘ²˜ [symbol] [0,∞].

The hierarchy helps in modeling rows and columns with lots of missing data, and in particular provides reasonable values also for rows with no observations through μᵣₘ.

A variational Bayesian approximation can be used to learn the model by minimizing the Kullback-Leibler divergence between a tractable approximation and the true observation probability. A fully factorized approximation and non-Gaussian likelihoods using quadratic bounds are used. For Gaussian data, the posterior is approximated with:

$$Q ( Θ ) = [ {\prod }_{e = 1}^{E} {\prod }_{k = 1}^{K} ( q ( {α}_{ek} ) {\prod }_{i = 1}^{{d}_{e}} q ( {u}_{ik}^{( e )} ) ) ] [ {\prod }_{m = 1}^{M} q ( {τ}_{m} ) q ( {μ}_{rm} ) q ( {μ}_{cm} ) {\prod }_{i = 1}^{{d}_{{r}_{m}}} q ( {b}_{i}^{( m , r )} ) {\prod }_{j = 1}^{{d}_{{c}_{m}}} q ( {b}_{j}^{( m , c )} ]$$

Here, q(α) and q(τ) are Gamma distributions, whereas the others are normal distributions. For all other parameters, closed-form updates are used, but Ūₑ, the mean parameters of q(Ue), are updated with Newton's method for each factor at a time. The gradient-based updates are used because for observation matrices with missing entries closed-form updates would be available only for each element ūᵢₖ^{(e)} separately, which would result in very slow convergence.

For non-Gaussian data, non-Gaussian likelihoods with spherical-variance Gaussians are used. This allows an optimization scheme that alternates between two steps: (i) updating Q(θ) given pseudo-data Z (which is assumed Gaussian), and (ii) updating the pseudo-data Z by optimizing a quadratic term lower-bounding the desired likelihood potential. The resulting equation is summarized as:

ξₘ=E[Uᵣ_{ₘ}]E[U_{c}_{ₘ}]^{T},

Zₘ=(ξₘ−f′ₘ(ξₘ)/κₘ),

where the updates are element-wise and independent for each matrix. Here f′ₘ(ξₘ) is the derivative of the m-th link function −log p(Xₘ|Uᵣ_{ₘ}U_{c}_{ₘ}^{T}) and κₘ is the maximum value of the second derivative of the same function. Given the pseudo-data Z, the approximation Q(θ) can be updated as in the Gaussian case, using τₘ=κₘ as the precision. Note that the link functions can be different for different observation matrices, which adds support for heterogeneous data.

Without intending to limit the scope of the exemplary embodiment, the following examples demonstrate the applicability of the method to prediction of demand for new stops and for prediction of geographical features.

### EXAMPLES

In the following examples, the method for mobility demand modeling is applied to passenger-count data and point-of-interest data for a large city in France. The demand of public transport is captured by fare collection data representing the number of passengers boarding public transport at a particular bus or tram stop at a given time of the day. The first boarding of a passenger at each given stop is used to count the number of passengers at each bus stop. Each stop is represented as a tuple {Route Id, Stop Id}. There are 769 stops over 37 routes. For each stop, the number of passengers is counted at 20-minutes interval in a 24 hour period. Thus, each stop is represented as a 72-dimensional vector. 20 weekdays' worth of data was collected and stops at each weekday as an independent sample were assumed. Thus, a passenger count matrix X of size 15,380×72 is created to represent the observed passenger counts.

To obtain the geographical features for each stop, such as the points-of-interest, the web based social media Foursquare was used. Foursquare provides information for 16 points-of-interest classes: (1) Arts-Entertainment, (2) College-University, (3) Food, (4) Nightlife.Spot, (5) Outdoors-Recreation, (6) Professional places, (7) Home-Private, (8) Residential-Building-Apartment-Condo, (9) Shop-Service, (10) Bus Station, (11) General-Travel, (12) Hotel, (13) Moving-Target, (14) Rental-Car-Location, (15) Road, and (16) Train-station.

In order to get the geographical information for each stop, the points-of-interest near each stop were counted within a 200 m radius. Thus, each stop is vector of 16 features counting different Foursquare venues within 200 m of the stop. Foursquare venue counts were further binned in {0,1,2}. In addition to these 16 points-of-interest, the geographical representations were enriched with the additional information. First, features representing stops—nearby and features representing whether a stop is close-to-tram were included. Second, a feature indicating how close each stop is to the end of the route was included. Third, 18 features counting different Foursquare venues within 200 m of other stops along the same route were included. These features were weighted so that venues around the nearest “close-by” stops had lower weight. Finally, 37 binary indicator features, one for each route, were included to indicate to which route(s) a particular stop belongs. These features account for the fact that a particular stop may belong to multiple routes.

Thus, the geographical representation of stops is a 769×74 dimensional matrix. In order to create a co-occurrence matrix with X, a 15,380×74 dimensional geographical matrix Y was created by duplicating unique stops. In this way, two data matrices were generated, (i) passenger count matrix X of size 15,380×72 and (ii) geographical matrix Y of size 15,380×74.

In addition, a third matrix Z of size 15,380×72 was created to represent average demand at each bus stop using passenger counts at neighboring stops, i.e., preceding and following stops. Matrix Z is used for comparative data in some of the examples below.

In order to estimate how accurately the predictive CCA and CMF models perform in practice, 70% of the stops for each route were randomly chosen as training data and the remaining 30% was left for testing. The model 36 is learned with the training data. Demand was then predicted for all the testing data, i.e., {route+stop} pairs. No demand data for the test stops was thus used in the prediction. Accuracy is measured by comparing the prediction with the average counts over the 20 days, which was used as a ground truth. For measuring accuracy, the flat error rate was computed between the predicted demand and the ground truth in two ways: (i) daily error as average absolute error of the day-wise count at each stop, and (ii) one-hour error as the average absolute error after re-discretizing the prediction for each hour (passengers between 8 AM-9 AM, passengers between 9 AM-10 AM and so on). For the one-hour error, only the hours with non-zero ground truth predictions were used.

### Example 1

In order to determine prediction accuracy of the CCA and CMF methods for modeling the dependence between mobility demand based on passenger counts and geographical information based on points-of-interest, predictions were computed and compared with a baseline mean-based prediction (MP). The following models were compared:

1. A CCA model incorporating passenger demand and geographical features (CCA-PD-POI).

2. A CCA model incorporating passenger demand and the average demand of neighboring stops (CCA-PD-AD).

3. A CCA model incorporating passenger demand and a simple concatenation of geographical features and the average demand (CCA-PD-(POI+AD)).

4. A CMF model combining passenger demand, geographical features, and average demand (CMF-PD-POI-AD).

These models were compared against the mean of all training samples for each route (MP). For each model, a 10-fold cross validation was used and the results were averaged to produce a single estimation. The number of factors K for the CCA and CMF models were chosen using cross validation to have the value of K with minimum error in each case. Table 1 summarizes prediction accuracy of the CCA variants, CMF, and baseline (mean-based prediction).

TABLE 1

| | One-hour prediction | Daily prediction |
|---|---|---|
| Method | error | error |
| Mean Prediction (MP) | 1.63 | 24.67 |
| CCA-PD-POI | 1.15 | 20.82 |
| CCA-PD-AD | 1.17 | 21.36 |
| CCA-PD-(POI + AD) | 1.14 | 20.33 |
| CMF-PD-POI-AD | 1.10 | 20.02 |

Lower error indicates higher accuracy. It can easily be seen from Table 1 that the CCA variant models and CMF model have a lower error rate for both one-hour and daily prediction when compared with the mean-based prediction baseline, which is computed at a route level. Table 1 further shows that the CCA-PD-POI model and CCA-PD-AD model perform similarly when incorporating geographical features and average demand of neighboring stops. However, the lowest error rates, and thus highest prediction accuracy, are achieved when the CCA and CMF models combine both feature types POI+AD. If the results are normalized so that CCA-PD-AD has a value of one, the addition of geographical features to average demand in the CCA-PD-(POI+AD) model is shown to further improve the results by 2.6% for one-hour prediction and 4.8% for daily prediction. Results are similarly improved for the CMF-PD-POI-AD model, where results are improved by 6% and 6.3% for one-hour prediction and daily prediction, respectively.

The results in TABLE 1 clearly show that the CCA based solution of jointly modeling passenger count and geographical neighborhood outperforms the baseline of mean-based prediction by clear margins. TABLE 1 also shows that using geographical information helps improve the prediction in the traditional method of using historical demand data.

### Example 2

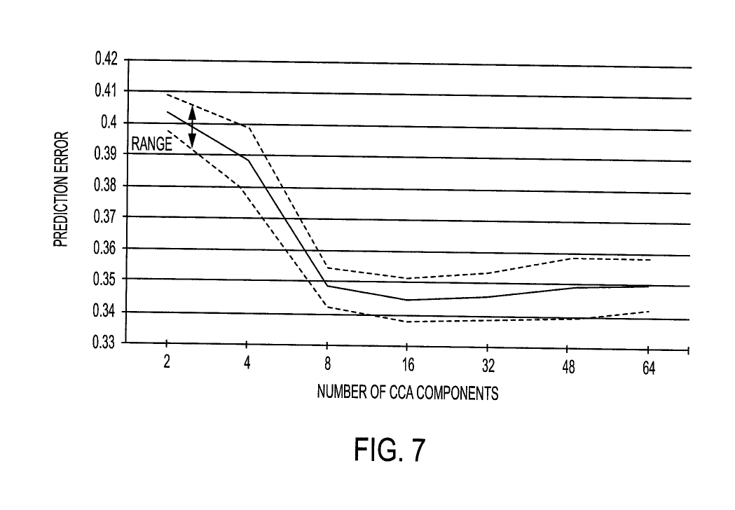

Demand data was used to predicting demography, i.e., points-of-interest. The results show that joint modeling of demand data and demographic data can be used to predict either of the data views. FIG. 7 shows the prediction error for demographic features using demand and route information for different numbers of CCA components. The results are relatively stable in the range of about 8-64 CCA components, with around 16 CCA components giving the best result on this data.

### Example 3

The predictive impact of the different geographical features in the method was analyzed. In particular, the dependence of mobility demand on different groups of POIs was investigated. The goal was to evaluate which type(s) of POIs had the greatest effect on demand. To do so, the points-of-interest were divided into three groups having similar demographic features. The first, transport related features (T), includes (11) General-Travel, (12) Hotel, (15) Road, and (16) Train-station. The second, leisure features (L), includes (2) College-University, (4) Nightlife.Spot, (5) Outdoors-Recreation, (6) Professional places, and (10) Bus Station. The third group, home/office/schools (H), includes (3) Food, (7) Home-Private, (8) Residential-Building-Apartment-Condo, and (9) Shop-Service.

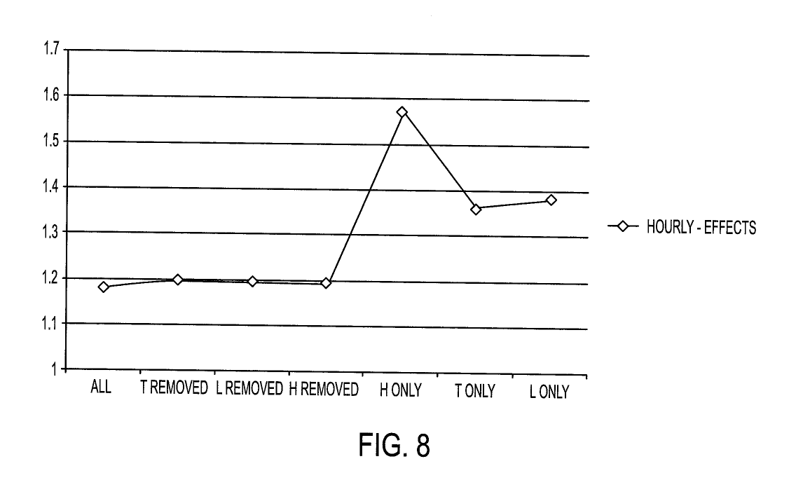

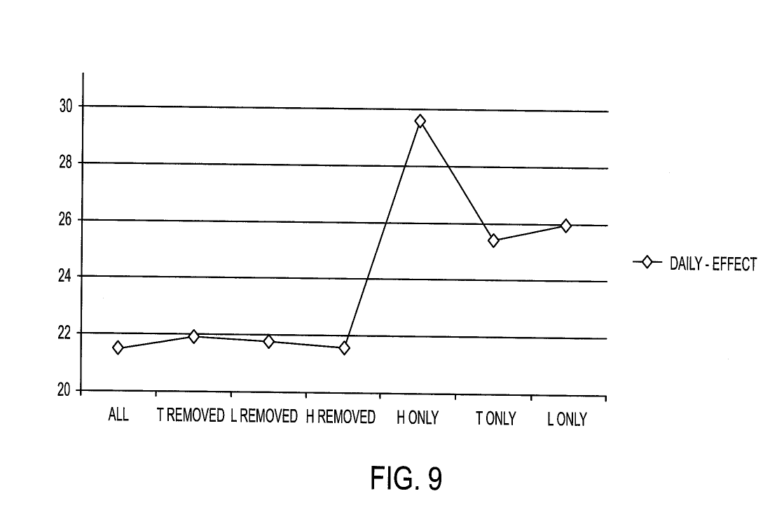

In order to understand the dependence of demand for each of the three point-of-interest groups, one of each of the point-of-interest groups T, L, or H was removed at a time and demand was predicted. FIGS. 8 and 9 show the results of these predictions. As can be seen in FIGS. 8 and 9, the lowest prediction error is achieved when all point-of-interest groups are included. The prediction error rises slightly when only one of groups T, L, or H is removed. However, when only one of T, L or H is considered, the prediction error rises considerably. The graphs suggest that the home/office/schools group H has the highest error prediction rate when considered alone, with leisure group L having the second highest rates and travel group T having the lowest, suggesting that home/office/school type points-of-interest have the least effect on mobility demand in a transportation network.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for modeling mobility demand, comprising:
providing passenger demand data for a transportation network, the passenger demand data comprising, for each of a plurality of stops in the transportation network, a passenger demand for each of a plurality of time intervals;
providing geographical data for the transportation network, the geographical data comprising, for each of the plurality of stops in the transportation network, geographical features representing local points-of-interest;
with a processor, modeling a dependence between the passenger demand data and the geographical data, the modeling comprising:
learning a first mapping function for embedding the passenger demand data into a latent space, and
learning a second mapping function for embedding the geographical data into the latent space,
the learning of the first and second mapping functions optimizing a correlation between the passenger demand data and the geographic data in the latent space.

2. The method of claim 1, further comprising, based on the dependence model generating at least one of:
a prediction of passenger demand for a proposed stop in the transportation network; and
a prediction of local points of interest for a stop in the transportation network.

3. The method of claim 1, wherein the passenger demand data forms a first matrix and the geographical data forms a second matrix.

4. The method of claim 3, further comprising generating the first matrix from passenger count observations for each of the plurality of stops.

5. The method of claim 3, further comprising generating the second matrix from points-of-interest observations.

6. The method of claim 3, the learning further comprising embedding a third matrix in the latent space, the third matrix being based on average passenger demand.

7. The method of claim 1, wherein each stop is associated with a stop identifier and a route identifier.

8. The method of claim 1, further comprising learning a third mapping function for embedding average demand data into the latent space, the learning of the first second and third mapping functions optimizing a correlation between the passenger demand data and the geographic data in the latent space.

9. The method of claim 1, wherein the modeling of the dependence between the passenger demand data and the geographical data is performed by multivariate regression.

10. The method of claim 9, wherein the multivariate regression is selected from Canonical Correlation Analysis and Collective Matrix Factorization.

11. The method of claim 1, wherein the geographical data further comprises features selected from the group consisting of:
features representing nearby stops in the transportation network;
features representing whether the stop is close to a stop of a different route or different mode of transport in the transportation network;
features indicating whether a stop is close to the end of its route on a transportation network;
features representing points-of-interest within a selected distance of other stops along a same route of the transportation network;
features representing to which route or routes each stop belongs; and
combinations thereof.

12. The method of claim 1, wherein the points-of-interest are each assigned to a respective class of points-of-interest, the geographical features representing a count for each of the classes.

13. The method of claim 12, wherein at least some of the classes are selected from the group consisting of:
Arts-Entertainment,
College-University,
Food,
Nightlife,
Outdoors-Recreation,
Professional places,
Residential
Shop-Service,
Bus Station,
Train-station;
General-Travel,
Hotel,
Moving-Target,
Rental-Car-Location,
Road; and
combinations and subgroups thereof.

14. The method of claim 12, wherein there are at least three points-of-interest classes.

15. The method of claim 1, wherein the passenger demand data is generated from at least one of automatic fare collection data and automatic passenger count data.

16. A system for predicting mobility demand, comprising memory which stores instructions for performing the method of claim 1 and a processor in communication with the memory for executing the instructions.

17. A computer program product comprising non-transitory memory storing instructions which, when executed by a computer, perform the method of claim 1.

18. A system for predicting mobility demand, comprising
a learning component which:
receives passenger demand data for a transportation network, the passenger demand data comprising, for each of a plurality of stops in the transportation network, a passenger demand for each of a plurality of time intervals;
receives geographical data for the transportation network, the geographical data comprising, for each of a plurality of stops in the transportation network, geographical features representing local points-of-interest;
generates a dependence model between the passenger demand data and the geographical data, comprising:
learning a first mapping function for embedding the passenger demand data into a latent space, and
learning a second mapping function for embedding the geographical data into the latent space,
the learning of the first and second mapping functions optimizing a correlation between the passenger demand data and the geographic data in the latent space;
a prediction component which generates a prediction based on the dependence model; and
a processor which implements the learning component and prediction component.

19. The system of claim 18, wherein the prediction component generates at least one of:
a prediction of passenger demand for a proposed stop in the transportation network; and
a prediction of local points of interest for a stop in the transportation network.

20. A method for predicting mobility demand, comprising:
providing a passenger demand matrix for a transportation network, where each row of the passenger demand matrix represents a respective combination of a route ID and a stop ID in the transportation network, each row comprising a vector of values, each value representing a passenger count for a respective one of a plurality of time intervals;
providing a geographical data matrix for the transportation network, where each row of the matrix represents a respective one of the combinations of route ID and stop ID in the transportation network, each row comprising a vector of values, each value representing a count of local points-of-interest for a respective one of a plurality of classes of points-of-interest;
learning a first mapping function for embedding the passenger demand matrix in a latent space and a second mapping function for embedding the geographical data matrix in the latent space which optimizes a correlation between the passenger demand matrix and the geographic data matrix in the latent space;
generating a prediction of passenger demand for a new stop in the transportation network based on the first and second mapping functions; and
outputting the prediction;
wherein at least one of the learning and the generating is performed with a processor.

21. The method of claim 20, further comprising providing an average passenger demand matrix for the transportation network, where each row of the average passenger demand matrix represents a respective one of the combinations of route ID and stop ID in the transportation network, each row comprising a vector of values, each value representing an average passenger count for a respective one of the plurality of time intervals, the average passenger count being based on passenger counts at preceding and following stops on the same route.
